(19) United States
(12) Patent Application Publication
(10) Pub. No.: US 2022/0390727 A1
(43) Pub. Date: Dec. 8, 2022

(54) FLAT-PLATE LENS AND OPTICAL IMAGING SYSTEM

(71) Applicant: BOE TECHNOLOGY GROUP CO., LTD., Beijing (CN)

(72) Inventors: Fang CHENG, Beijing (CN); Tao HONG, Beijing (CN); Zhenxing ZHOU, Beijing (CN)

(73) Assignee: BOE TECHNOLOGY GROUP CO., LTD., Beijing (CN)

(21) Appl. No.: 17/778,038

(22) PCT Filed: May 20, 2021
(86) PCT No.: PCT/CN2021/094758

§ 371 Date: May 19, 2022

(30) Foreign Application Priority Data
Jun. 24, 2020 (CN) 202010592563.X

(51) Int. Cl. G02B 17/06; G02B 13/18

(52) U.S. Cl. CPC G02B 17/0642; G02B 17/0621; G02B 13/18

(57) ABSTRACT

A flat-plate lens and an optical imaging system are provided. The flat-plate lens, includes a first face and a second face, the first face includes a ring-shaped light-transmitting region and a first reflective region surrounded by the ring-shaped light-transmitting region, and the second face includes an imaging region and a second reflective region surrounding the imaging region. The second reflective region is configured to reflect light to the first reflective region, and the first reflective region is configured to reflect light to the imaging region; the second reflective region includes a first mirror. The first mirror is one selected from the group consisting of a free-form curved mirror, an aspheric mirror and a spherical mirror, and the first reflective region includes at least one selected from the group consisting of a free-form curved mirror, an aspheric mirror, a spherical mirror and a plane mirror.

The present application claims the priority of the Chinese patent application No. 202010592563.X filed on Jun. 24, 2020, for all purposes, the disclosure of which is incorporated herein by reference in its entirety as part of the present application.

### TECHNICAL FIELD

At least one embodiment of the present disclosure relates to a flat-plate lens and an optical imaging system.

### BACKGROUND

At present, the thickness of an optical imaging system such as a mobile phone or a camera is greatly influenced by the thickness of camera lens. In order to reduce the thicknesses of mobile phones and portable cameras, and maintain relatively good image quality at the same time, lens design in the optical imaging system is becoming more and more important.

### SUMMARY

At least one embodiment of the present disclosure provides a flat-plate lens and an optical imaging system.

At least one embodiment of the present disclosure provides a flat-plate lens, which includes a first face and a second face facing each other, the first face includes a ring-shaped light-transmitting region and a first reflective region surrounded by the ring-shaped light-transmitting region, and the second face includes an imaging region and a second reflective region surrounding the imaging region. The second reflective region is configured to reflect light incident from the ring-shaped light-transmitting region to the first reflective region, and the first reflective region is configured to reflect light incident to the first reflective region to the imaging region; the second reflective region includes a first mirror configured to directly reflect light incident on the first mirror through the ring-shaped light-transmitting region to the first reflective region, the first mirror is one selected from the group consisting of a free-form curved mirror, an aspheric mirror and a spherical mirror, and the first reflective region includes at least one selected from the group consisting of a free-form curved mirror, an aspheric mirror, a spherical mirror and a plane mirror.

For example, in an embodiment of the present disclosure, a thickness of the flat-plate lens is less than 3 mm.

For example, in an embodiment of the present disclosure, the first mirror is a ring-shaped mirror, and an orthographic projection of the ring-shaped light-transmitting region on the second face completely falls within an orthographic projection of the first mirror on the second face.

For example, in an embodiment of the present disclosure, a ratio of a maximum size of an outer contour of the first mirror to a maximum size of an outer contour of the ring-shaped light-transmitting region is greater than 1 and less than 1.5.

For example, in an embodiment of the present disclosure, a ratio of a maximum size of the first reflective region to a ring width of the ring-shaped light-transmitting region is greater than 0.5.

For example, in an embodiment of the present disclosure, in the first reflective region and the second reflective region, a sum of a number of a plane mirror and a number of a spherical mirror is greater than a sum of a number of a free-form curved mirror and a number of an aspheric mirror.

For example, in an embodiment of the present disclosure, a maximum field angle of light incident on the flat-plate lens is 10°.

For example, in an embodiment of the present disclosure, the first reflective region includes a second mirror close to the ring-shaped light-transmitting region, and the first mirror is configured to reflect the light incident from the ring-shaped light-transmitting region to the second mirror.

For example, in an embodiment of the present disclosure, the second mirror is configured to directly reflect light incident on the second mirror to the imaging region, and the second mirror is a plane mirror or a spherical mirror.

For example, in an embodiment of the present disclosure, the second mirror is configured to directly reflect light incident on the second mirror to the imaging region, the first mirror and the second mirror are both aspheric mirrors, and a thickness of the flat-plate lens is not more than 2 mm.

For example, in an embodiment of the present disclosure, the second reflective region further includes a third mirror located between the first mirror and the imaging region, the third mirror surrounds the imaging region, and the first reflective region further includes a fourth mirror located at a side of the second mirror away from the ring-shaped light-transmitting region, the second mirror is configured to reflect light incident on the second mirror to the third mirror, and the third mirror is configured to reflect light incident on the third mirror to the fourth mirror.

For example, in an embodiment of the present disclosure, the first mirror and the third mirror are concentric ring structures, and/or the second mirror and the fourth mirror are concentric structures.

For example, in an embodiment of the present disclosure, the fourth mirror is configured to directly reflect light incident on the fourth mirror to the imaging region, and the second mirror, the third mirror and the fourth mirror are all plane mirrors or spherical mirrors.

For example, in an embodiment of the present disclosure, the fourth mirror is configured to directly reflect the light incident on the fourth mirror to the imaging region, the first mirror and the fourth mirror are aspheric mirrors, the second mirror is a free-form curved mirror, and the third mirror is a plane mirror.

For example, in an embodiment of the present disclosure, a thickness of the flat-plate lens is not more than 2 mm.

For example, in an embodiment of the present disclosure, the second reflective region further includes a fifth mirror located between the third mirror and the imaging region, the fifth mirror surrounds the imaging region, and the first reflective region further includes a sixth mirror located at a side of the fourth mirror away from the ring-shaped light-transmitting region, the fourth mirror is configured to reflect light incident on the fourth mirror to the fifth mirror, and the fifth mirror is configured to reflect light incident on the fifth mirror to the sixth mirror.

For example, in an embodiment of the present disclosure, the sixth mirror is configured to directly reflect light incident on the sixth mirror to the imaging region, and the second mirror, the third mirror, the fourth mirror, the fifth mirror and the sixth mirror are all plane mirrors or spherical mirrors.

Another embodiment of the present disclosure provides an optical imaging system, which includes the flat-plate lens as mentioned above and a sensor. The sensor is located in the imaging region of the flat-plate lens, and the light incident from the ring-shaped light-transmitting region is only reflected by the first reflective region and the second reflective region before entering the sensor.

### BRIEF DESCRIPTION OF THE DRAWINGS

In order to more clearly explain the technical scheme of the embodiments of the present disclosure, the following will briefly introduce the drawings of the embodiments. Obviously, the drawings in the following description only relate to some embodiments of the present disclosure, but not limit the present disclosure.

FIG. 1 is a schematic cross-sectional view of a flat-plate lens according to an example of an embodiment of the present disclosure;

FIG. 2 is a schematic plan view of a first face of the flat-plate lens shown in FIG. 1;

FIG. 3 is a schematic plan view of a second face of the flat-plate lens shown in FIG. 1;

FIG. 4 is a schematic diagram of a partial cross-sectional structure of a flat-plate lens according to another example of an embodiment of the present disclosure;

FIG. 5A is a spot diagram of the flat-plate lens shown in FIG. 4;

FIGS. 5B to 5F are enlarged views of spots shown in FIG. 5A;

FIG. 6 is a curve diagram of a modulation transfer function of the flat-plate lens shown in FIG. 4;

FIG. 7 is a schematic cross-sectional structure diagram of a flat-plate lens according to another example of an embodiment of the present disclosure;

FIG. 8 is a schematic plan view of the first face of the flat-plate lens shown in FIG. 7;

FIG. 9 is a schematic plan view of the second face of the flat-plate lens shown in FIG. 7;

FIG. 10 is a schematic diagram of a partial cross-sectional structure of a flat-plate lens according to another example of an embodiment of the present disclosure;

FIG. 11A is a spot diagram of the flat-plate lens shown in FIG. 10;

FIGS. 11B to 11E are enlarged views of spots shown in FIG. 11A;

FIG. 12 is a curve diagram of a modulation transfer function of the flat-plate lens shown in FIG. 10;

FIG. 13 is a schematic cross-sectional structure diagram of a flat-plate lens according to another example of an embodiment of the present disclosure;

FIG. 14 is a schematic diagram of a partial sectional structure of an optical imaging system according to another embodiment of the present disclosure; and

FIG. 15 is a schematic plan view of an optical imaging system according to another example of an embodiment of the present disclosure.

### DETAILED DESCRIPTION

In order to make objects, technical details and advantages of embodiments of the present disclosure clear, the technical solutions of the embodiments will be described in a clearly and fully understandable way in connection with the related drawings. It is apparent that the described embodiments are just a part but not all of the embodiments of the present disclosure. Based on the described embodiments herein, those skilled in the art can obtain, without any inventive work, other embodiment(s) which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the description and claims of the present disclosure, are not intended to indicate any sequence, amount or importance, but distinguish various components. The terms “comprises,” “comprising,” “includes,” “including,” etc., are intended to specify that the elements or the objects stated before these terms encompass the elements or the objects listed after these terms as well as equivalents thereof, but do not exclude other elements or objects.

In the research, the inventor(s) of the present application found that the mobile phone lens often adopts a lens structure including a plurality of lenses, the thickness of each of the lens in the lens structure will affect the thickness of the mobile phone lens, and it is difficult to conduct an ultra-thin improvement to the lens structure.

Embodiments of the present disclosure provide a flat-plate lens and an optical imaging system. The flat-plate lens includes a first face and a second face facing each other, the first face includes a ring-shaped light-transmitting region and a first reflective region surrounded by the ring-shaped light-transmitting region, and the second face includes an imaging region and a second reflective region surrounding the imaging region. The second reflective region is configured to reflect light incident from the ring-shaped light-transmitting region to the first reflective region, and the first reflective region is configured to reflect light incident to the first reflective region to the imaging region; the second reflective region includes a first mirror configured to directly reflect light incident on the first mirror through the ring-shaped light-transmitting region to the first reflective region. The first mirror is one selected from the group consisting of a free-form curved mirror, an aspheric mirror and a spherical mirror, and the first reflective region includes at least one selected from the group consisting of a free-form curved mirror, an aspheric mirror, a spherical mirror and a plane mirror. The flat-plate lens provided by the embodiment of the present disclosure adopts a reflection system including the first reflective region and the second reflective region, which can not only ensure that no chromatic aberration occurs in the imaging process, but also reduce the thickness and weight of the flat-plate lens by setting fewer mirrors.

Hereinafter, the flat-plate lens and the optical imaging system provided by the embodiments of the present disclosure will be described below with reference to the accompanying drawings.

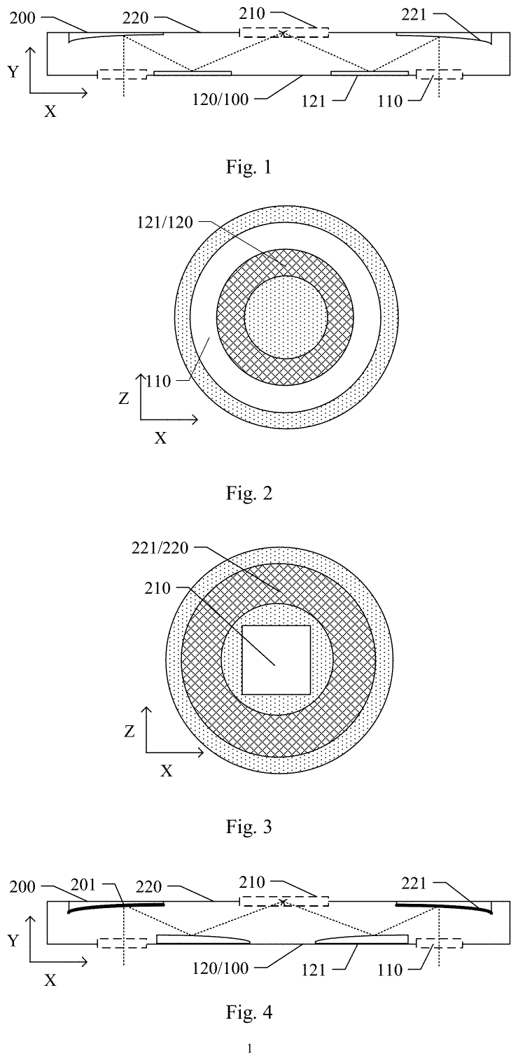

FIG. 1 is a schematic cross-sectional structure diagram of a flat-plate lens according to an example of an embodiment of the present disclosure, FIG. 2 is a schematic plan view of a first face of the flat-plate lens shown in FIG. 1, and FIG. 3 is a schematic plan view of a second face of the flat-plate lens shown in FIG. 1. As illustrated by FIGS. 1 to 3, the flat-plate lens includes a first face 100 and a second face 200 facing each other. The first face 100 includes a ring-shaped light-transmitting region 110 and a first reflective region 120 surrounded by the ring-shaped light-transmitting region 110, and the second face 200 includes an imaging region 210 and a second reflective region 220 surrounding the imaging region 210. The second reflective region 220 is configured to reflect light incident from the ring-shaped light-transmitting region 110 to the first reflective region 120, and the first reflective region 120 is configured to reflect light incident from the second reflective region 220 to the first reflective region 120 to the imaging region 210. The light incident from the ring-shaped light-transmitting region 110 is only reflected by the first reflective region 120 and the second reflective region 220 before entering the imaging region 210. Compared the flat-plate lens adopting lenses, in the flat-plate lens provided by the embodiment of the present disclosure, the light incident on the flat-plate lens from the ring-shaped light-transmitting region 110 is not transmitted by any lens, but is reflected by a reflection system including the first reflective region 120 and the second reflective region 220 and then incident to the imaging region 210. Therefore, the flat-plate lens provided by the embodiment of the present disclosure can not only realize a thinner thickness without considering the thickness of the lens superposition, but also eliminate the chromatic aberration generated in the imaging process. The above-mentioned “the light incident from the ring-shaped light-transmitting region 110 is only reflected by the first reflective region 120 and the second reflective region 220 before entering the imaging region 210” refers to that the light incident from the ring-shaped light-transmitting region 110 is not transmitted by any lens before entering the imaging region 210, and the reflection process may also include absorption of the light by the reflective regions. For example, air can be used as the light transmission medium during the abovementioned reflection of light, which can effectively reduce the production cost of the flat-plate lens.

As illustrated by FIGS. 1 to 3, the second reflective region 220 includes a first mirror 221 facing the ring-shaped light-transmitting region 110, and the first mirror 221 is configured to directly reflect light incident on the first mirror 221 passing through the ring-shaped light-transmitting region 110 to the first reflective region 120. The first mirror 221 is one selected from the group consisting of a free-form curved mirror, an aspheric mirror and a spherical mirror, and the first reflective region 120 includes at least one selected from the group consisting of a free-form curved mirror, an aspheric mirror, a spherical mirror and a plane mirror. The first mirror is directly opposite to the ring-shaped light-transmitting region in a Y direction shown in FIG. 1. For example, the Y direction can be a propagation direction of the light incident to the ring-shaped light-transmitting region. The first mirror in the embodiment of the present disclosure adopts a free-form curved mirror, an aspheric mirror or a spherical mirror, which can better reflect the light incident from the ring-shaped light-transmitting region to the first reflective region.

For example, as illustrated by FIGS. 1 to 3, the first face 100 and the second face 200 may both be planar. However, the embodiment of the present disclosure is not limited thereto, and at least one of the first face and the second face may also be a curved surface.

For example, the first mirror 221 can be a spherical mirror to save the manufacturing cost.

For example, the first mirror 221 can be an aspheric mirror or a free-form curved mirror to better ensure the imaging quality of the flat-plate lens.

For example, a thickness of the flat-plate lens is less than 3 mm. For example, the thickness of the flat-plate lens may refer to an average value of distances between the first face 100 and the second face 200 at different positions. For example, the thickness of the flat-plate lens can refer to a distance between a plane where the imaging region is located and a plane where the ring-shaped light-transmitting region is located. The imaging region of the flat-plate lens in the embodiment of the present disclosure is configured to place a sensor to receive the light incident from the ring-shaped light-transmitting region and convert an optical signal into an electrical signal. In the embodiment of the present disclosure, the flat-plate lens realizes multiple reflection folding technology through the first reflective region and the second reflective region, which can reduce the thickness of the flat-plate lens while ensuring the image quality, and realize the flat-plate lens with compact optical path structure.

For example, as illustrated by FIG. 1 to FIG. 3, the first mirror 221 can be a ring-shaped mirror, and an orthographic projection of the ring-shaped light-transmitting region 110 on the second face 200 completely falls within an orthographic projection of the first mirror 221 on the second face 200. For example, a ratio of the maximum size of an outer contour of the first mirror 221 to the maximum size of an outer contour of the ring-shaped light-transmitting region 110 is greater than 1 and less than 1.5. For example, along a X direction, a ring width of the first mirror 221 is larger than that of the ring-shaped light-transmitting region 110, and the first mirror 221 completely covers the ring-shaped light-transmitting region 110, which can ensure that the light with a predetermined field angle among the light incident on the flat-plate lens from the ring-shaped light-transmitting region 110 is basically reflected to the first reflective region 120, thereby improving the utilization rate of the light.

For example, FIG. 3 schematically shows that the shapes of the ring-shaped light-transmitting region 110 and the first mirror 221 are both circular rings, but not limited thereto, the shapes of the ring-shaped light-transmitting region 110 and the first mirror 221 can also be square rings or other rings. The shape of the ring-shaped light-transmitting region can be the same as or different from that of the first mirror, as long as the orthographic projection of the ring-shaped light-transmitting region 110 on the second face 200 completely falls within the orthographic projection of the first mirror 221 on the second face 200. FIG. 3 schematically shows that the imaging region is rectangular, but it is not limited thereto, and the imaging region can also be other regular or irregular shapes such as circle.

For example, FIG. 3 schematically shows that the shape of the first mirror 221 is a closed ring to improve the utilization rate of light, but is not limited thereto. Under the condition of ensuring the brightness of the incident light, the shape of the first mirror may be a non-closed ring.

For example, as illustrated by FIG. 2, a ratio of a ring width of the ring-shaped light-transmitting region 110 to the maximum size of the first reflective region 120 is not more than 1. For example, a ratio of the maximum size of the first reflective region 120 to the ring width of the ring-shaped light-transmitting region 110 is greater than 0.5. In the embodiment of the present disclosure, by designing the ratio of the maximum size of the first reflective region to the ring width of the ring-shaped light-transmitting region, the brightness of the light entering the flat-plate lens and the brightness of the light incident to the imaging region can be ensured.

For example, as illustrated by FIGS. 1 to 3, the first reflective region 120 may include at least one mirror, and the second reflective region 220 may include at least one mirror.

For example, as illustrated by FIGS. 1 to 3, the first reflective region 120 includes a second mirror 121 close to the ring-shaped light-transmitting region 110, and the first mirror 221 is configured to reflect light incident to the ring-shaped light-transmitting region 110 to the second mirror 121. For example, the embodiment of the present disclosure schematically shows that an orthographic projection of the first mirror 221 on the first face 100 overlaps with an orthographic projection of the second mirror 121 on the first face 100. In this embodiment of the disclosure, taking the first face as an example, the overlap between the first mirror and the second mirror in a direction perpendicular to the first face can reduce the length or width of the flat-plate lens. However, the embodiment of the present disclosure is not limited thereto. In the direction perpendicular to the first face, the first mirror and the second mirror may not overlap, as long as the light incident from the ring-shaped light-transmitting region can be reflected to the imaging region.

For example, the second mirror 121 can be a ring-shaped mirror, for example, a closed ring or an unclosed ring, so as to reflect as much light as possible from the first mirror 221 to the first reflective surface 120 to the imaging region. The embodiment of the present disclosure is not limited thereto, and the second mirror may have other shapes under the condition of ensuring the intensity of the light incident to the imaging region.

For example, the second mirror 121 and the ring-shaped light-transmitting region 110 can be coaxial rings, which is convenient for design and conducive to the propagation of light. The embodiment of the present disclosure is not limited thereto. For example, the second mirror can also be a circular mirror, a square mirror, etc. In this case, the second mirror and the ring-shaped light-transmitting region are concentric structures. The embodiment of the present disclosure includes but is not limited thereto, as long as the light incident on the second mirror can be reflected to the imaging region.

For example, an edge of the second mirror 121 may be in contact with an edge of the ring-shaped light-transmitting region 110, or may have a certain distance.

For example, as illustrated by FIGS. 1 to 3, the second mirror 121 is configured to directly reflect the light incident on the second mirror 121 to the imaging region 210. For example, the orthographic projection of the second mirror 121 on the second face 200 overlaps with the imaging region 210. For example, the flat-plate lens includes a two times reflection structure, that is, the second reflective region 220 only reflects light once, for example, the second reflective region 220 only includes one first mirror, and the first reflective region 120 only reflects light once, for example, the first reflective region 120 only includes one second mirror. The light incident on the first mirror 221 from the ring-shaped light-transmitting region 110 (for example, a light aperture) is reflected to the second mirror 121, and the second mirror 121 reflects and converges light incident on the second mirror 121 to the imaging region 210.

For example, upon mirrors in flat-plate lens being designed, an aspheric mirror or a free-form curved mirror should be reasonably used to effectively correct and balance aberrations, so that the imaging quality can meet the requirements. In the visible light band, because the costs of aspheric mirror and free-form curved mirror are hundreds of times of the cost of spherical mirror, so the manufacturing cost of aspheric mirror and free-form curved mirror is relatively high. At present, the design, processing, inspection and adjustment of aspheric mirror or free-form curved mirror have gradually matured, so it is feasible to apply aspheric mirror and free-form curved mirror in the flat-plate lens. The problem of using aspheric mirrors and free-form curved mirrors in the flat-plate lenses is mainly a technological problem, which includes the possibility of batch manufacturing, processing and testing. However, stamping with plastic film can solve the processing problem of general aspheric mirror and free-form curved mirror, so that the thickness of flat-plate lens can be obviously reduced by using aspheric mirror and free-form curved mirror. Using the two times reflection structure can not only facilitate processing, but also simplify the process of system correction and aberration balance.

For example, as illustrated by FIG. 1, the second mirror 121 may be a plane mirror or a spherical mirror. In the embodiment of the present disclosure, on the premise of ensuring the imaging quality, plane mirrors or spherical mirrors are used as much as possible, and thereby reducing the use of free-form curved mirror and aspheric mirror, and saving the cost.

For example, FIG. 4 is a schematic diagram of a partial cross-sectional structure of a flat-plate lens according to another example of an embodiment of the present disclosure. As illustrated by FIG. 4, the flat-plate lens includes a two times reflection structure, the first mirror 221 is configured to reflect the light incident to the ring-shaped light-transmitting region 110 to the second mirror 121, and the second mirror 121 is configured to directly reflect the light incident on the second mirror to the imaging region 210. Herein, “the second mirror is configured to directly reflect the light incident on the second mirror to the imaging region 210” refers to that the light reflected from the second mirror is incident on a sensor located in the imaging region without passing through other optical elements.

For example, a surface of at least one mirror in the second reflective region 220 is provided with a reflective film 201 to make the light incident to the imaging region 210 form light with a predetermined field angle, so as to prevent the light incident to the imaging region 210 outside the predetermined field angle entering the imaging region 210, and the light incident to the imaging region 210 outside the predetermined field angle is regarded as stray light. Stray light is the general term of all abnormal transmitted light in the optical system. The influence of stray light on the performance of the optical system varies with different systems.

For example, a reflective surface of the first mirror 221 may be provided with a reflective film 201, which may completely cover the reflective surface of the first mirror 221. However, the embodiment of the present disclosure is not limited thereto, but the reflective film 201 may also cover a part of the reflective surface of the first mirror. In the embodiment of the present disclosure, by arranging the reflective film 201 on the first mirror 221, the light within a certain angle range can be reflected in the reflective regions, so that the light entering the imaging region 210 is basically the light entering the imaging region 210 at a predetermined field angle.

For example, the maximum field angle of the light incident into the flat-plate lens from the ring-shaped light-transmitting region is 10°.

For example, the reflective film 201 may be an angle reflective film, and the material of the reflective film 201 may include a metal film layer or a filter layer, etc.

For example, as illustrated by FIG. 4, in an example of an embodiment of the present disclosure, both the first mirror 221 and the second mirror 121 are both aspheric mirrors, and the thickness of the flat-plate lens is not more than 2 mm. The thickness of the flat-plate lens refers to an average distance between the first face 100 and the second face 200.

For example, a working wavelength band of the flat-plate lens can be 484-656 nm, that is, the wavelength band of the light incident to the imaging region 210 includes 484-656 nm. For example, the flat-plate lens in the embodiment of the present disclosure is designed based on the visible light band, but it is not limited thereto, and it can also be designed only for light of a certain band.

For example, a rotationally symmetric polynomial aspheric surface is described by adding a polynomial to a spherical surface (or aspheric surface determined by four times surface). Even aspheric model only uses even power of radial coordinate value to describe aspheric surface. This model uses the basic curvature radius and four times coefficient. The aspheric surface coordinates are expressed by the following numerical formula:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16}$$

In the above formula, c is the basic curvature at the center of curvature (i.e., the reciprocal of curvature radius), k is the conic coefficient (i.e., conic curve constant), r is the radial coordinate perpendicular to the optical axis, and the 2n-th aspheric coefficient is an in turn. In this example, the specific parameters of the optimized flat-plate lens are shown in Table 1.

TABLE 1

| | Curvature | Distance/ | Optical | Conic |
|---|---|---|---|---|
| | radius/mm | mm | material | coefficient |
| Object plane | infinite | infinite | — | — |
| Ring-shaped | infinite | 0.5834 | — | — |
| light-transmitting | | | | |
| region | | | | |
| First mirror | −12.502 | 0.402 | Reflective | 3.202 |
| | | | material | |
| Second mirror | 2.1903 | 0.811 | Reflective | −12.082 |
| | | | material | |
| Imaging region | infinite | 0 | — | — |

The curvature radius of the aspheric mirror shown in Table 1 is the curvature radius of a base sphere of its surface. The above-mentioned “base sphere” refers to that the aspheric surface is formed by further deformation based on a sphere, and the sphere as the basis of the aspheric surface is the base sphere of the aspheric surface. With reference to the parameters in FIG. 4 and table 1, it can be seen that the distance between the first face where the ring-shaped light-transmitting region 110 is located and the reflective surface of the first mirror 121 is 0.5834 mm, the distance between the reflective surface of the first mirror 221 and the reflective surface of the second mirror 121 is 0.402 mm, and the distance between the reflective surface of the second mirror 121 and the second face where the imaging region 210 is located is 0.811 mm. Then the thickness of the flat-plate lens in the example shown in FIG. 4 can be 2 mm. The distance between the reflective surface and the reflective surface refers to a distance along the optical axis after the mirror is eccentric. The distance between the reflective surface of the mirror and the first face or second face refers to a distance between the intersection of the reflective surface and the optical axis and the first face or second face along the optical axis direction.

The automatic optical design software will retrieve the curvature radius, conic coefficient, height and aspheric coefficient of each mirror from the database in turn and put them into the above numerical formula for calculation to obtain the optimized parameters that can correct the aberration of the mirror. Through the optimization process, the optimal values of the curvature radius, thickness along the optical axis, aperture and conic coefficient of each mirror in the flat-plate lens are obtained. Through the optimized simulated structure of the flat-plate lens, it can be found that the thickness of the flat-plate lens is not more than 2 mm.

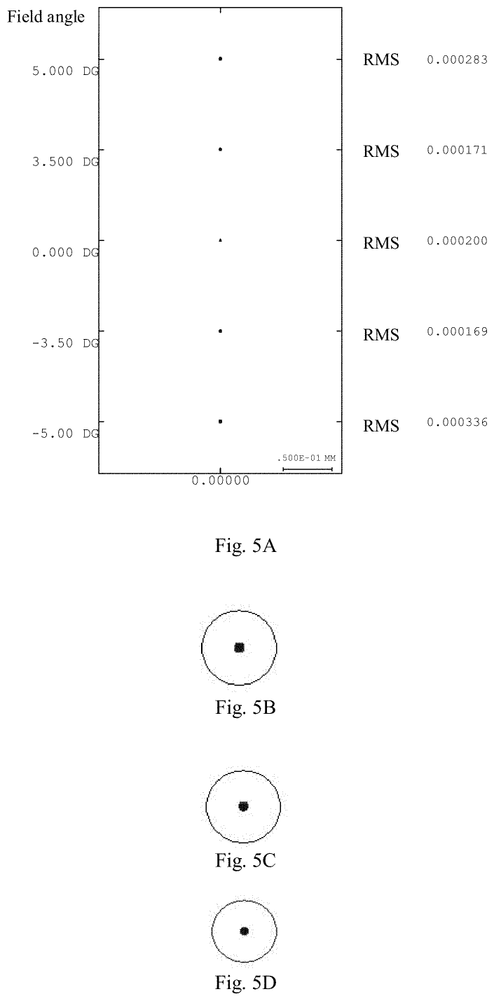

For example, FIG. 5A is a spot diagram of the flat-plate lens shown in FIG. 4, and FIGS. 5B to 5F are enlarged views of the spots shown in FIG. 5A. FIG. 5A to FIG. 5F show the focusing of light on an image plane of the imaging region. As illustrated by FIG. 5A, the spot diagram includes the spots upon the filed angle (DG) being −5°, −3.5°, 0°, 3.5° and 5° in turn, and the root mean square (RMS) values of the diameter of the spot diagram corresponding to the above five filed angles are 0.336 μm, 0.169 μm, 0.2 μm, 0.171 μm and 0.283 μm in turn. For example, the radius of the disc of confusion of the flat-plate lens shown by FIG. 4 is not more than 3.5 μm and the size of the pixel of the detector set at the position of the imaging region 210 is not less than 4 μm, then the root mean square of the diameter of the spot diagram is less than the size of the pixel of the detector. FIG. 5B to FIG. 5F respectively correspond to the spots upon the field angles being −5°, −3.5°, 0°, 3.5° and 5° in turn, and the circles in the figures represent the pixel sizes of the detector, and the light spots in the circles are disc of confusions. Therefore, the spot diagram of all fields of view on the image plane of the imaging region basically falls within the size range of the pixel of the detector, so that the flat-plate lens has the focusing characteristics close to the diffraction theoretical limit.

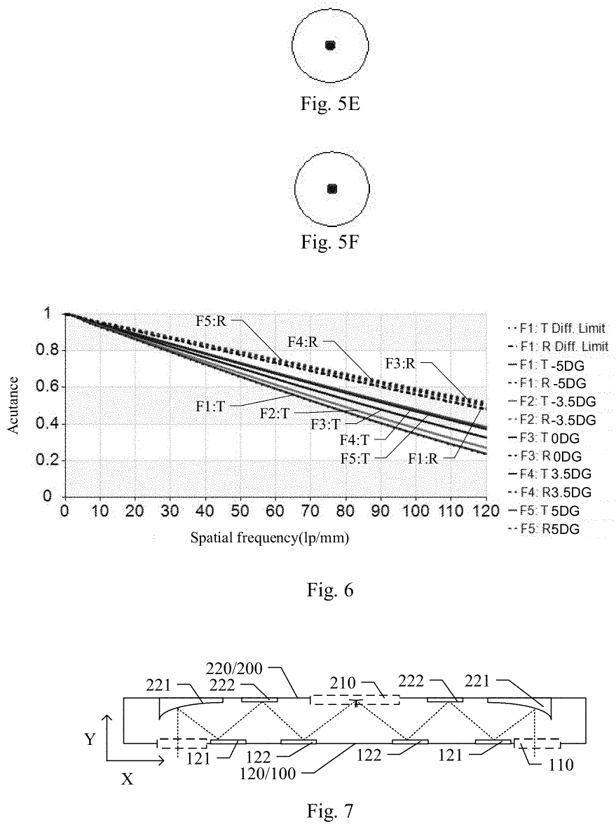

For example, FIG. 6 is a curve diagram of a modulation transfer function of the flat-plate lens shown in FIG. 4. As illustrated by FIG. 6, the curve diagram includes optical transfer function values at different spatial frequency of meridians F1:T, F2:T, F3:T, F4:T, F5:T and sagittal line F1:R, F2:R, F3:R, F4:R, F5:R upon the field angles being −5°, −3.5°, 0°, 3.5° and 5° in turn. In the curve diagram, the curves of the transfer functions of the fields are close to the diffraction limits, and the contrast at the position where the spatial frequency is 110 line pairs/mm (lp/mm) is larger than 0.3, and then the resolution of the display image can be 1920*1080 and the imaging is clear. The T Diff. Limit in the figure represents the meridian under the diffraction limit, and the R Diff. Limit represents the sagittal line under the diffraction limit, which basically coincide with the meridian F1:T and the sagittal line F1:R upon the field angle being −5°, respectively.

Of course, in the case where the first reflective region only includes one second mirror and the second reflective region only includes one first mirror, the first mirror and the second mirror are not limited to both aspheric mirrors, as long as the combination of the first mirror and the second mirror can achieve the required imaging effect and facilitate processing. For example, the first mirror can be a spherical mirror, and the second mirror can be a plane mirror or a spherical mirror to save the manufacturing cost. For example, the first mirror can be an aspheric mirror or a free-form curved mirror, and the second mirror can be a plane mirror or a spherical mirror to better ensure the imaging quality of the flat-plate lens.

For example, FIG. 7 is a schematic cross-sectional structure diagram of a flat-plate lens provided by another example of an embodiment of the present disclosure. As illustrated by FIG. 7, the flat-plate lens includes a first face 100 and a second face 200 facing each other. The first face 100 includes a ring-shaped light-transmitting region 110 and a first reflective region 120 surrounded by the ring-shaped light-transmitting region 110, and the second face 200 includes an imaging region 210 and a second reflective region 220 surrounding the imaging region 210. The second reflective region 220 is configured to reflect the light incident from the ring-shaped light-transmitting region 110 to the first reflective region 120, and the first reflective region 120 is configured to reflect light incident from the second reflective region 220 to the first reflective region 120 to the imaging region 210. The light incident from the ring-shaped light-transmitting region 110 is only subjected to the reflection of the first reflective region 120 and the second reflective region 220 before entering the imaging region 210, that is, the light incident on the flat-plate lens from the ring-shaped light-transmitting region 110 does not pass through any lens, but only enters the imaging region 210 after being reflected by a reflection system including the first reflective region 120 and the second reflective region 220, thereby eliminating the color difference generated in the imaging process. For example, air can be used as the light transmission medium during the reflection of the above light, which can effectively reduce the production cost of flat-plate lens.

For example, as illustrated by FIG. 7, the second reflective region 220 includes a first mirror 221 facing the ring-shaped light-transmitting region 110, and the first mirror 221 is configured to directly reflect light incident on the first mirror 221 through the ring-shaped light-transmitting region 110 to the first reflective region 120. The first mirror 221 is one selected from the group consisting of a free-form curved mirror, an aspheric mirror and a spherical mirror, and the first reflective region 120 includes at least one selected from the group consisting of a free-form curved mirror, an aspheric mirror, a spherical mirror and a plane mirror. The first mirror faces the ring-shaped light-transmitting region in a Y direction shown in FIG. 7, and the Y direction can be a direction of the light incident to the ring-shaped light-transmitting region. The first mirror in the embodiment of the present disclosure adopts a free-form curved mirror, an aspheric mirror or a spherical mirror, which can better converge the light incident from the ring-shaped light-transmitting region to the first reflective region.

For example, as illustrated by FIG. 7, the first face 100 and the second face 200 may both be planar. However, the embodiment of the present disclosure is not limited thereto, and at least one of the first face and the second face may also be a curved surface.

For example, the first reflective region 120 includes a second mirror 121 close to the ring-shaped light-transmitting region 110, and the first mirror 221 is configured to reflect the light incident to the ring-shaped light-transmitting region 110 to the second mirror 121. For example, as illustrated by FIG. 7, the second reflective region 220 further includes a third mirror 222 located between the first mirror 221 and the imaging region 210, the third mirror 222 surrounds the imaging region 210. The first reflective region 120 further includes a fourth mirror 122 located at a side of the second mirror 121 away from the ring-shaped light-transmitting region 110. The second mirror 121 is configured to reflect the light incident on the second mirror 121 to the third mirror 222. The third mirror 222 is configured to reflect light incident on the third mirror 222 to the fourth mirror 122, and the fourth mirror 122 is configured to directly reflect the light incident on the fourth mirror 122 to the imaging region 210.

For example, the first mirror 221, the second mirror 121, the third mirror 222 and the fourth mirror 122 may all be spherical mirrors. For example, the first mirror 221 can be an aspheric mirror or a free-form curved mirror, and the second mirror 121, the third mirror 222 and the fourth mirror 122 can be plane mirrors or spherical mirrors to better ensure the imaging quality of the flat-plate lens. In the embodiment of the present disclosure, on the premise of ensuring the imaging quality, plane mirrors or spherical mirrors are used as much as possible, thereby reducing the use of free-form curved mirrors and aspheric mirrors and saving the cost.

For example, in the first reflective region 120 and the second reflective region 220, a sum of a number of the plane mirrors and a number of the spherical mirrors is greater than a sum of a number of the free-form curved mirrors and a number of the aspheric mirrors, so that the manufacturing cost can be saved on the basis of ensuring the imaging quality of the flat-plate lens.

For example, the thickness of the flat-plate lens is less than 2 mm. The thickness here refers to an average value of the distance between the first face 100 and the second face 200. The flat-plate lens in the embodiment of the present disclosure realizes the multiple reflection folding technology through the first reflective region and the second reflective region, which can reduce the thickness of the flat-plate lens while ensuring the image quality, so as to make the optical path structure of the flat-plate lens more compact.

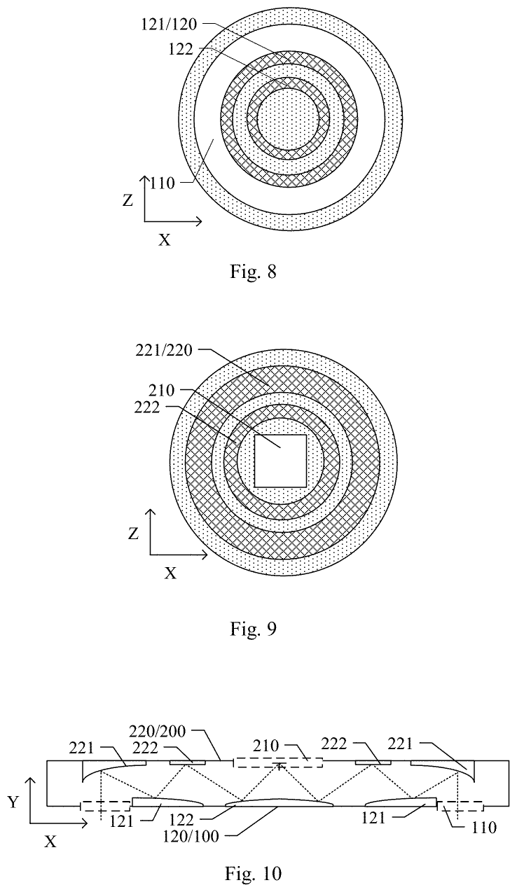

For example, FIG. 8 is a schematic plan view of the first face of the flat-plate lens shown in FIG. 7, and FIG. 9 is a schematic plan view of the second face of the flat-plate lens shown in FIG. 7. As illustrated by FIG. 7 to FIG. 9, the first mirror 221 can be a ring-shaped mirror, and an orthographic projection of the ring-shaped light-transmitting region 110 on the second face 200 completely falls within an orthographic projection of the first mirror 221 on the second face 200, thereby improving the utilization rate of light.

For example, the first mirror 221 and the third mirror 222 are concentric ring structures which are spaced apart from each other to better converge the light incident from the ring-shaped light-transmitting region 110 to the imaging region 210. For example, the second mirror 121 and the fourth mirror 122 are concentric structures which are spaced apart from each other to better converge the light incident from the ring-shaped light-transmitting region 110 to the imaging region 210. FIG. 8 schematically shows that the fourth mirror is ring-shaped, but the embodiment of the present disclosure is not limited thereto. The fourth mirror can also be circular or square, as long as the light incident on the fourth mirror can be reflected to the imaging region. The embodiment of the present disclosure is not limited to the situation that there is an interval between the mirrors on the same reflective surface, but the mirrors on the same reflective surface can also be connected with each other.

For example, as illustrated by FIG. 7, a ratio of the ring width of the ring-shaped light-transmitting region 110 to the maximum size of the first reflective region 120 is not more than 1. In the embodiment of the present disclosure, by designing the ratio of the maximum size of the first reflective region to the ring width of the ring-shaped light-transmitting region, the brightness of the light entering the flat-plate lens and the brightness of the light incident to the imaging region can be ensured.

For example, a surface of at least one mirror in the second reflective region 220 is provided with a reflective film 201 to reduce stray light incident to the imaging region 210. For example, the reflective surface of at least one of the first mirror 221 and the third mirror 222 may be provided with a reflective film, which may completely cover the reflective surface of the corresponding mirror. But the embodiment of the present disclosure is not limited thereto, and the reflective film may also cover a part of the reflective surface of the corresponding mirror. The reflective film in this example can have the same characteristics as the reflective film in the example shown in FIG. 4, and the repeated portions will not be described in detail here.

For example, FIG. 10 is a schematic diagram of a partial cross-sectional structure of a flat-plate lens according to another example of an embodiment of the present disclosure. As illustrated by FIG. 10, the flat-plate lens includes a four times reflection structure, the first mirror 221 is configured to reflect the light incident to the ring-shaped light-transmitting region 110 to the second mirror 121, the second mirror is configured to reflect the light incident thereon to the third mirror 222, and the third mirror 222 is configured to reflect the light incident thereon to the fourth mirror 122. The fourth mirror 122 is configured to directly reflect the light incident on the fourth mirror 122 to the imaging region 210. The first mirror 221 and the third mirror 222 are an aspheric mirror and a plane mirror, respectively. The second mirror 121 is a free-form curved mirror and the fourth mirror 122 is an aspheric mirror, and the thickness of the plane lens is not more than 2 mm. The above-mentioned “the fourth mirror 122 is configured to directly reflect the light incident on the fourth mirror 122 to the imaging region 210” refers to that the light reflected from the fourth mirror is directly incident on the sensor located in the imaging region without passing through other optical structures. The four times reflection structure can not only achieve thinner thickness, for example, no more than 1.7 mm or even less than 1 mm, but also achieve better imaging effect by optimizing the optical parameters of the plurality of mirrors, and the difficulty of the optimization process is moderate, so it is suitable for higher resolution products.

For example, the working wavelength band of the flat-plate lens can be 484-656 nm, that is, the wavelength band of the light incident to the imaging region 210 includes 484-656 nm. For example, the maximum field angle of the flat-plate lens is 10°.

For example, the aspheric surface type is expressed by the following numerical formula:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} + {a}_{8} {r}^{16}$$

In the above formula, c is the basic curvature at the center of curvature (i.e., the reciprocal of curvature radius), k is the conic coefficient (i.e., conic constant), r is the radial coordinate perpendicular to the optical axis, and the 2n-th aspheric coefficient is an in turn. In this example, the specific parameters of the optimized flat-plate lens are shown in Table 2.

The free-form surface is obtained according to the following formula:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$

In the above formula, N is a total number of polynomial coefficients in the series, and Ai is the coefficient of the i-th extended polynomial. The polynomial is only a power series in the X and Y directions. For example, the power series can sequentially include x, y, x*x, x*y and y*y, etc. In the above power series, there are 2 linear terms, 3 quadratic terms and 4 cubic terms, etc., and the highest order term is 20, so that the maximum value of the total number of polynomial aspheric coefficients is 230. The data values of x and y positions are divided by a normalized radius to obtain a polynomial coefficient without dimension.

TABLE 2

| | Curvature | Distance/ | Optical | Conic |
|---|---|---|---|---|
| | radius/mm | mm | material | coefficient |
| Object plane | infinite | infinite | — | — |
| Ring-shaped | infinite | −5.60 | — | — |
| light-transmitting | | | | |
| region | | | | |
| First mirror | −25.951 | 8.320 | Reflective | 2.013 |
| | | | material | |
| Second mirror | 15.612 | −1.04 | Reflective | −1.1132 |
| | | | material | |
| Third mirror | infinite | −1.04 | Reflective | 0 |
| | | | material | |
| Fourth mirror | 15.4243 | 1.04 | Reflective | −6.5 |
| | | | material | |
| Imaging region | infinite | 0 | — | — |

Referring to the parameters in FIG. 10 and Table 2, it can be seen that the distance between the first face where the ring-shaped light-transmitting region is located and the reflective surface of the first mirror is −5.60 mm, the distance between the reflective surface of the first mirror and the reflective surface of the second mirror is 8.320 mm, the distance between the reflective surface of the second mirror and the reflective surface of the third mirror is −1.04 mm, and the distance between the reflective surface of the third mirror and the reflective surface of the fourth mirror is −1.04 mm, the distance between the reflective surface of the fourth mirror and the second face where the imaging region is located is 1.04 mm, and then the thickness of the flat-plate lens in the example shown in FIG. 10 may be 1.598 mm. The distance between the reflective surface and the reflective surface can refer to the distance between the mirrors along the optical axis after being eccentric, and the distance between the reflective surface of the mirrors and the first face or second face refers to the distance between the reflective surface and the first face or second face along the optical axis. A negative distance between the first face and the reflective surface of the first mirror indicates that the distance from the first face to the reflective surface is opposite to the propagation direction of light. For example, the first mirror may be an eccentric mirror whose curvature center is not located on the optical axis.

The automatic optical design software will retrieve the curvature radius, conic coefficient, height and aspheric coefficient of each mirror from the database in turn and put them into the above numerical formula for calculation to obtain the optimized parameters that can correct the aberration of the mirror. Through the optimization process, the optimal values of the curvature radius, thickness along the optical axis, aperture and conic coefficient of each mirror in the flat-plate lens are obtained. Through the optimized simulated structure of the flat-plate lens, it can be found that the thickness of the flat-plate lens is not more than 1.598 mm.

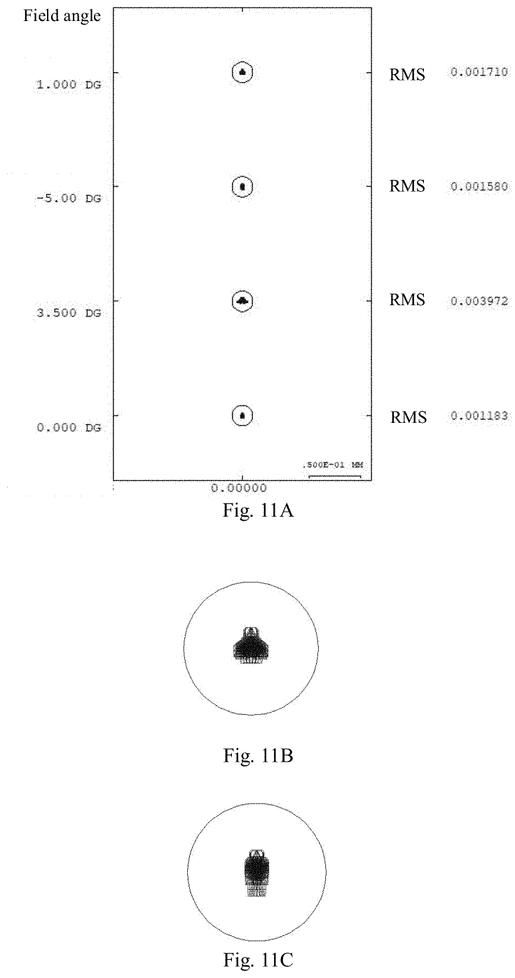

For example, FIG. 11A is a spot diagram of the flat-plate lens shown in FIG. 10, and FIGS. 11B to 11E are enlarged views of the spots shown in FIG. 11A. FIG. 11A to FIG. 11E show the focusing of light on an image plane of the imaging region. As illustrated by FIG. 5A, the spot diagram includes the spots upon the filed angle being 1°, −5°, 3.5°, and 0° in turn, and the root mean square (RMS) values of the diameter of the spot diagram corresponding to the above four filed angles are 1.71 μm, 1.58 μm, 3.972 μm and 1.183 μm in turn. For example, the radius of the disc of confusion of the flat-plate lens shown by FIG. 11A is not more than 3.5 μm and the size of the pixel of the detector set at the position of the imaging region 210 is not less than 4 μm, then the root mean square of the diameter of the spot diagram is less than the size of the pixel of the detector. FIG. 11B to FIG. 11E respectively correspond to the spots upon the filed angle being 1°, −5°, 3.5°, and 0° in turn, and the circles in the figures represent the pixel sizes of the detector, and the light spots in the circles are disc of confusions. Therefore, the spot diagram of all fields of view on the image plane of the imaging region basically falls within the size range of the pixel of the detector, so that the flat-plate lens has the focusing characteristics close to the diffraction theoretical limit. The Y Diff. Limit in the figure represents the meridian under the diffraction limit, and the X Diff. Limit represents the sagittal line under the diffraction limit.

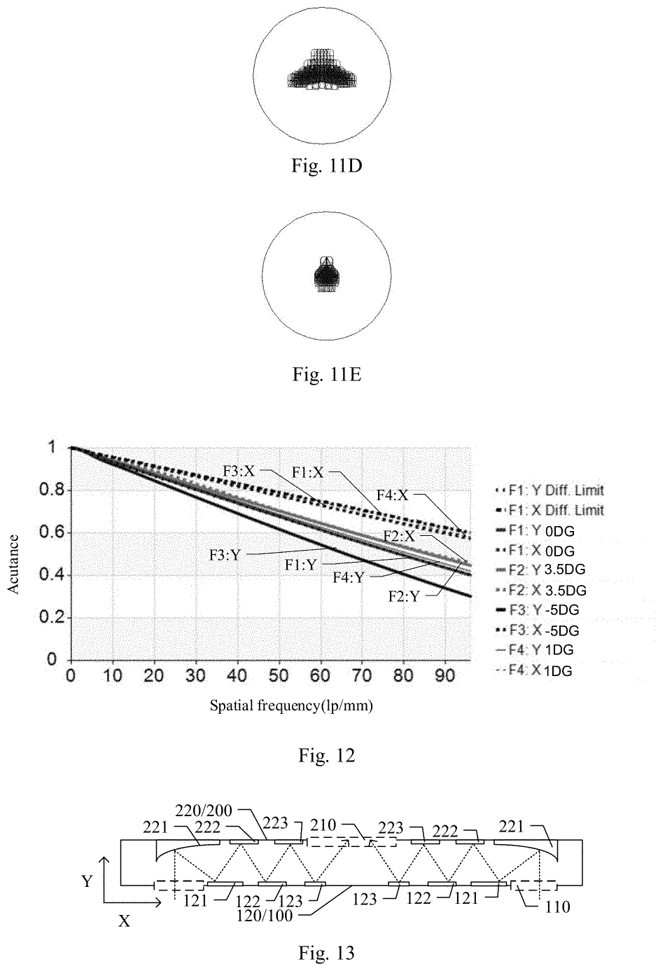

For example, FIG. 12 is a modulation curve diagram of a transfer function of the flat-plate lens shown in FIG. 10. As illustrated by FIG. 12, the curve diagram includes the optical transfer function values at different spatial frequencies of the meridian F1:Y, F2:Y, F3:Y, F4:Y and the sagittal lines F1:X, F2:X, F3:X, F4:X upon the field angles being 0°, 3.5°, −5° and 1° in turn. In the curve diagram, the curves of the transfer functions of the fields are close to the diffraction limits, and the contrast at the position where the spatial frequency is 90 line pairs/mm (lp/mm) is larger than 0.3, the imaging is clear.

Of course, in the case where the first reflective region only includes two mirrors and the second reflective region only includes two mirrors, the first mirror and the fourth mirror are not limited to aspheric mirrors, the second mirror is not limited to a free-form curved mirror, and the third mirror is not limited to a plane mirror, as long as the combination of the first mirror to the fourth mirror can achieve the required imaging effect and facilitate processing.

TABLE 3

| | Curvature | Distance/ | Optical | Conic |
|---|---|---|---|---|
| | radius/mm | mm | material | coefficient |
| Object plane | infinite | infinite | — | — |
| Ring-shaped | infinite | −1.632 | — | — |
| light-transmitting | | | | |
| region | | | | |
| First mirror | −11.308 | 2.277 | Reflective | 2.013 |
| | | | material | |
| Second mirror | 4.626 | −0.126 | Reflective | −1.1132 |
| | | | material | |
| Third mirror | infinite | −0.581 | Reflective | 0 |
| | | | material | |
| Fourth mirror | 6.085 | 0.581 | Reflective | −6.5 |
| | | | material | |
| Imaging region | infinite | 0 | — | — |

The structure of the flat-plate lens corresponding to the parameters shown in Table 3 is the same as that of the flat-plate lens shown in FIG. 10, but the thickness of the flat-plate lens shown in FIG. 10 can be made smaller, for example, 1-2 mm, for example, 0.998 mm, by adjusting the curvature radius of each mirror, the distance between mirrors and other parameters. Through the optimized simulated structure of flat-plate lens, the thickness of flat-plate lens is 0.998 mm, for example.

For example, referring to the parameters in FIG. 10 and Table 3, it can be seen that the distance between the first face where the ring-shaped light-transmitting region is located and the reflective surface of the first mirror is −1.632 mm, the distance between the reflective surface of the first mirror and the reflective surface of the second mirror is 2.277 mm, the distance between the reflective surface of the second mirror and the reflective surface of the third mirror is −0.126 mm, and the distance between the reflective surface of the third mirror and the reflective surface of the fourth mirror is −0.581 mm, and the distance between the reflective surface of the fourth mirror and the second face where the imaging region is located is 0.581 mm. Corresponding to the flat-plate lens in Table 3, the spot diagram of all fields on the image plane of the imaging region basically falls within the size range of pixels of the detector, so the flat-plate lens has focusing characteristics close to the diffraction theoretical limit. In addition, the contrast of the flat-plate lens at the position where the spatial frequency is 80 line pairs/mm (lp/mm) is greater than 0.3, and the imaging is clear. The distance between the reflective surface and the reflective surface can refer to the distance along the optical axis direction after the reflective surface is eccentric. The distance between the reflective surface of the mirror and the first face or second face refers to the distance between the intersection of the reflective surface and the optical axis and the first face or second face along the optical axis direction. Compared with Table 2 and Table 3, for the four times reflection structure, on the premise of ensuring the imaging quality, the thickness of the flat-plate lens can be further reduced by reducing the curvature radius of each mirror and optimizing the distance between respective reflection surfaces.

For example, FIG. 13 is a schematic cross-sectional structure diagram of a flat-plate lens provided for another example of an embodiment of the present disclosure. As illustrated by FIG. 13, the flat-plate lens includes a first face 100 and a second face 200 facing each other. The first face 100 includes a ring-shaped light-transmitting region 110 and a first reflective region 120 surrounded by the ring-shaped light-transmitting region 110, and the second face 200 includes an imaging region 210 and a second reflective region 220 surrounding the imaging region 210. The second reflective region 220 is configured to reflect the light incident from the ring-shaped light-transmitting region 110 to the first reflective region 120, and the first reflective region 120 is configured to reflect the light incident from the second reflective region 220 to the first reflective region 120 to the imaging region 210. Before entering the imaging region 210, the light incident from the ring-shaped light-transmitting region 110 is only subjected to the reflection of the first reflective region 120 and the second reflective region 220, that is, the light incident on the flat-plate lens from the ring-shaped light-transmitting region 110 does not pass through any lens, but only enters the imaging region 210 after being reflected by a reflection system including the first reflective region 120 and the second reflective region 220, thereby eliminating the color difference generated in the imaging process. For example, air can be used as the light transmission medium during the reflection of the above light, which can effectively reduce the production cost of flat-plate lens.

For example, as illustrated by FIG. 13, the second reflective region 220 includes a first mirror 221 facing the ring-shaped light-transmitting region 110, and the first mirror 221 is configured to directly reflect the light incident on the first mirror 221 through the ring-shaped light-transmitting region 110 to the first reflective region 120. The first mirror 221 is one selected from the group consisting of a free-form curved mirror, an aspheric mirror and a spherical mirror, and the first reflective region 120 includes at least one selected from the group consisting of a free-form curved mirror, an aspheric mirror, a spherical mirror and a plane mirror. The first mirror faces the ring-shaped light-transmitting region in a Y direction shown in FIG. 13, and the Y direction can be the direction of the light incident to the ring-shaped light-transmitting region. The first mirror in the embodiment of the present disclosure adopts a free-form curved mirror, an aspheric mirror or a spherical mirror, which can better converge the light incident from the ring-shaped light-transmitting region to the first reflective region.

For example, as illustrated by FIG. 13, the first face 100 and the second face 200 may both be planar. However, it is not limited thereto, and at least one of the first face and the second face may also be a curved surface.

For example, the first reflective region 120 includes a second mirror 121 close to the ring-shaped light-transmitting region 110, and the first mirror 221 is configured to reflect the light incident to the ring-shaped light-transmitting region 110 to the second mirror 121. For example, as illustrated by FIG. 13, the second reflective region 220 further includes a third mirror 222 located between the first mirror 221 and the imaging region 210, the third mirror 222 surrounds the imaging region 210. The first reflective region 120 further includes a fourth mirror 122 located at a side of the second mirror 121 away from the ring-shaped light-transmitting region 110. The second mirror 121 is configured to reflect the light incident on the second mirror 121 to the third mirror 222, and the third mirror 222 is configured to reflect the light incident on the third mirror 222 to the fourth mirror 122. For example, as illustrated by FIG. 13, the second reflective region 220 further includes a fifth mirror 223 located between the third mirror 222 and the imaging region 210, the fifth mirror 223 surrounds the imaging region 210, and the first reflective region 120 further includes a sixth mirror 123 located at a side of the fourth mirror 122 away from the ring-shaped light-transmitting region 110, the fourth mirror 122 is configured to reflect the light incident on the fourth mirror 122 to the fifth mirror 223. The fifth mirror 223 is configured to reflect the light incident on the fifth mirror 223 to the sixth mirror 123, and the sixth mirror 123 is configured to directly reflect the light incident on the sixth mirror 123 to the imaging region 210. Therefore, the flat-plate lens includes a six times reflection structure that reflects the light incident from the ring-shaped light-transmitting region to the imaging region through six reflections. The thickness of the flat-plate lens with the six reflection structure can be further reduced, for example, the thickness of the flat-plate lens is less than 1 mm.

For example, the first mirror 221, the second mirror 121, the third mirror 222, the fourth mirror 122, the fifth mirror 223 and the sixth mirror 123 may all be spherical mirrors. For example, the first mirror 221 can be an aspheric mirror or a free-form curved mirror, and the second mirror 121, the third mirror 222, the fourth mirror 122, the fifth mirror 223 and the sixth mirror 123 can be plane mirrors or spherical mirrors to better ensure the imaging quality of the flat-plate lens. In the embodiment of the present disclosure, on the premise of ensuring the imaging quality, plane mirrors or spherical mirrors are used as much as possible, thereby reducing the use of free-form curved mirrors and aspheric mirrors and saving the cost.

For example, in the first reflective region 120 and the second reflective region 220, a sum of a number of the plane mirrors and a number of the spherical mirrors is greater than a sum of a number of the free-form curved mirrors and a number of the aspheric mirrors, so that the manufacturing cost can be saved on the basis of ensuring the imaging quality of the flat-plate lens.

For example, the thickness of the flat-plate lens is less than 2 mm. In the embodiment of the present disclosure, the flat-plate lens realizes multiple reflection folding technology through the first reflective region and the second reflective region, which can reduce the thickness of the flat-plate lens while ensuring the image quality, and realize the compact design of the optical path structure in flat-plate lens.

For example, the first mirror, the third mirror and the fifth mirror are concentric ring structures which are spaced apart from each other to better converge the light incident from the ring-shaped light-transmitting region to the imaging region. For example, the second mirror, the fourth mirror and the sixth mirror are concentric structures which are spaced apart from each other to better converge the light incident from the ring-shaped light-transmitting region to the imaging region. For example, the sixth mirror can be ring-shaped, but the embodiment of the present disclosure is not limited thereto, and the sixth mirror can also be circular, square and other structures, as long as the light incident on the sixth mirror can be reflected to the imaging region. For example, there may be a gap between at least two mirrors on the same reflective surface, but the embodiment is not limited thereto, and at least two mirrors on the same reflective surface may also be connected with each other.

For example, a ratio of the ring width of the ring-shaped light-transmitting region 110 to the maximum size of the first reflective region 120 is not more than 1. In the embodiment of the present disclosure, by designing the ratio of the maximum size of the first reflective region to the ring width of the ring-shaped light-transmitting region, the thickness of the flat-plate lens can be reduced as much as possible while ensuring the brightness of the light entering the flat-plate lens and the brightness of the light entering the imaging region.

For example, the surface of at least one mirror in the second reflective region is provided with a reflective film to reduce stray light of light incident to the imaging region. For example, the reflective surface of at least one of the first mirror, the third mirror and the fifth mirror may be provided with a reflective film, which may completely cover the reflective surface of the corresponding mirror. But the embodiment of the present disclosure is not limited thereto, and the reflective film may also cover a part of the reflective surface of the corresponding mirror. The reflective film in this example can have the same characteristics as the reflective film in the example shown in FIG. 4, and the repeated portions will not be described in detail here.

For example, in each example of the embodiment of the present disclosure, at least one of the first face and the second face of the flat-plate lens may be an optical plastics substrate. The mirrors located on the same surface can be machined by diamond cutting die and then by injection molding, so as to realize mass production.

Diamond cutting technology can be used to manufacture high-quality infrared optical devices, and can also be used to make good surface patterns that produce visible light. Therefore, the optical system that needs thin and high-quality imaging can be further satisfied by this technology.

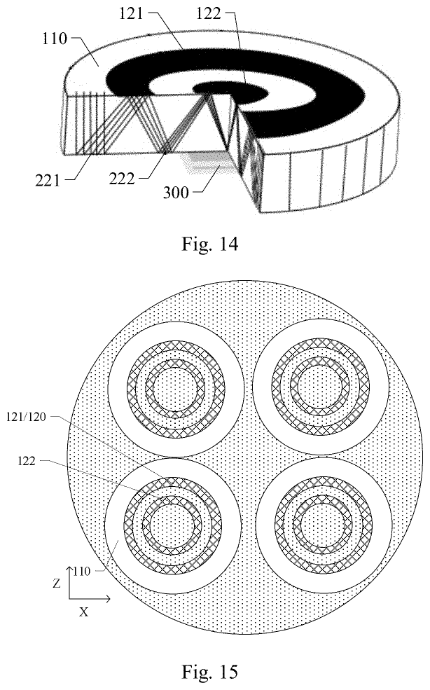

FIG. 14 is a schematic diagram of a partial sectional structure of an optical imaging system according to another embodiment of the present disclosure, including the flat-plate lens provided in any of the above examples. FIG. 14 schematically shows that the flat-plate lens in the optical imaging system is the flat-plate lens shown in FIG. 10. As illustrated by FIG. 14, the optical imaging system also includes a sensor 300, which is located in the imaging region of the flat-plate lens. The light incident from the ring-shaped light-transmitting region 110 is only reflected by the first reflective region and the second reflective region before entering the sensor 300. That is, the light incident on the flat-plate lens from the ring-shaped light-transmitting region 110 is not transmitted by any lens, but is reflected by the reflection system including the first reflective region 120 and the second reflective region 220 and then incident on the sensor 300 of the imaging region 210, which can reduce the thickness of the optical imaging system.

For example, as illustrated by FIG. 14, the sensor 300 completely covers the imaging region so that all the light reflected to the imaging region can be received by the sensor 300 to convert the optical signal into an electrical signal. For example, the sensor 300 may include a charge coupled device (CCD) or a complementary metal-oxide-semiconductor image sensor (CMOS).

For example, as illustrated by FIG. 14, the sensor 300 can be directly attached to the imaging region of the flat-plate lens, and there are no other optical structures such as lenses between the sensor 300 and the flat-plate lens, so as to further reduce the thickness of the optical imaging system. For example, the sensor can be embedded in the flat-plate lens to further reduce the thickness of the optical imaging system.

For example, the optical imaging system provided by the embodiment of the present disclosure can be a device such as a mobile phone or a portable camera, and the thinness of the optical imaging system such as a mobile phone or a camera can be realized by designing a thin flat-plate lens.

For example, FIG. 15 is a schematic plan view of an optical imaging system according to another example of an embodiment of the present disclosure. FIG. 15 schematically shows the structure of the first face of the flat-plate lens. As illustrated by FIG. 15, a plurality of flat-plate lenses can be located on the same substrate, so that, by adopting a field splicing method, a plurality of flat-plate lenses can be spliced in field to obtain an optical imaging system such as an ultra-thin light field camera with a large field and high resolution.

There are some points to be illustrated:

(1) Drawings of the embodiments of the present disclosure only refer to structures related with the embodiments of the present disclosure, and other structures may refer to general design.

(2) In case of no conflict, features in the same embodiment and different embodiments of the present disclosure may be combined with one another.

The foregoing embodiments merely are exemplary embodiments of the present disclosure, and not intended to define the scope of the present disclosure, and the scope of the present disclosure is determined by the appended claims.

1. A flat-plate lens, comprising:
a first face and a second face facing each other, wherein the first face comprises a ring-shaped light-transmitting region and a first reflective region surrounded by the ring-shaped light-transmitting region, and the second face comprises an imaging region and a second reflective region surrounding the imaging region,
wherein the second reflective region is configured to reflect light incident from the ring-shaped light-transmitting region to the first reflective region, and the first reflective region is configured to reflect light incident to the first reflective region to the imaging region;
the second reflective region comprises a first mirror configured to directly reflect light incident on the first mirror through the ring-shaped light-transmitting region to the first reflective region, the first mirror is one selected from the group consisting of a free-form curved mirror, an aspheric mirror and a spherical mirror, and the first reflective region comprises at least one selected from the group consisting of a free-form curved mirror, an aspheric mirror, a spherical mirror and a plane mirror.

2. The flat-plate lens according to claim 1, wherein a thickness of the flat-plate lens is less than 3 mm.

3. The flat-plate lens according to claim 1, wherein the first mirror is a ring-shaped mirror, and an orthographic projection of the ring-shaped light-transmitting region on the second face completely falls within an orthographic projection of the first mirror on the second face.

4. The flat-plate lens according to claim 3, wherein a ratio of a maximum size of an outer contour of the first mirror to a maximum size of an outer contour of the ring-shaped light-transmitting region is greater than 1 and less than 1.5.

5. The flat-plate lens according to claim 1, wherein a ratio of a maximum size of the first reflective region to a ring width of the ring-shaped light-transmitting region is greater than 0.5.

6. The flat-plate lens according to claim 1, wherein, in the first reflective region and the second reflective region, a sum of a number of a plane mirror and a number of a spherical mirror is greater than a sum of a number of a free-form curved mirror and a number of an aspheric mirror.

7. The flat-plate lens according to claim 1, wherein a maximum field angle of light incident on the flat-plate lens is 10°.

8. The flat-plate lens according to claim 1, wherein the first reflective region comprises a second mirror close to the ring-shaped light-transmitting region, and the first mirror is configured to reflect the light incident from the ring-shaped light-transmitting region to the second mirror.

9. The flat-plate lens according to claim 8, wherein the second mirror is configured to directly reflect light incident on the second mirror to the imaging region, and the second mirror is a plane mirror or a spherical mirror.

10. The flat-plate lens according to claim 8, wherein the second mirror is configured to directly reflect light incident on the second mirror to the imaging region, the first mirror and the second mirror are both aspheric mirrors, and a thickness of the flat-plate lens is not more than 2 mm.

11. The flat-plate lens according to claim 8, wherein the second reflective region further comprises a third mirror located between the first mirror and the imaging region, the third mirror surrounds the imaging region, and the first reflective region further comprises a fourth mirror located at a side of the second mirror away from the ring-shaped light-transmitting region, the second mirror is configured to reflect light incident on the second mirror to the third mirror, and the third mirror is configured to reflect light incident on the third mirror to the fourth mirror.

12. The flat-plate lens according to claim 11, wherein the first mirror and the third mirror are concentric ring structures, and/or the second mirror and the fourth mirror are concentric structures.

13. The flat-plate lens according to claim 11, wherein the fourth mirror is configured to directly reflect light incident on the fourth mirror to the imaging region, and the second mirror, the third mirror and the fourth mirror are all plane mirrors or spherical mirrors.

14. The flat-plate lens according to claim 11, wherein the fourth mirror is configured to directly reflect the light incident on the fourth mirror to the imaging region, the first mirror and the fourth mirror are aspheric mirrors, the second mirror is a free-form curved mirror, and the third mirror is a plane mirror.

15. The flat-plate lens according to claim 14, wherein a thickness of the flat-plate lens is not more than 2 mm.

16. The flat-plate lens according to claim 11, wherein the second reflective region further comprises a fifth mirror located between the third mirror and the imaging region, the fifth mirror surrounds the imaging region, and the first reflective region further comprises a sixth mirror located at a side of the fourth mirror away from the ring-shaped light-transmitting region, the fourth mirror is configured to reflect light incident on the fourth mirror to the fifth mirror, and the fifth mirror is configured to reflect light incident on the fifth mirror to the sixth mirror.

17. The flat-plate lens according to claim 16, wherein the sixth mirror is configured to directly reflect light incident on the sixth mirror to the imaging region, and the second mirror, the third mirror, the fourth mirror, the fifth mirror and the sixth mirror are all plane mirrors or spherical mirrors.

18. An optical imaging system, comprising:
the flat-plate lens according to claim 1 and a sensor,
wherein the sensor is located in the imaging region of the flat-plate lens, and the light incident from the ring-shaped light-transmitting region is only reflected by the first reflective region and the second reflective region before entering the sensor.
